(19) United States
(12) Patent Application Publication
(10) Pub. No.: US 2008/0027900 A1
(43) Pub. Date: Jan. 31, 2008

(54) Method and system for optimal selection of targets based on business rules and resource availability

(75) Inventors: Walter C. Dietrich, Yorktown Heights, NY (US); John P. Fasano, Briarcliff Manor, NY (US); Jonathan Lee, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/484,588

(22) Filed: Jul. 12, 2006

(51) Int. Cl. G06F 7/00

(52) U.S. Cl. 707/2; 705/1; 705/7; 700/28

(57) ABSTRACT

A method and system for solving a problem construct. The problem construct includes an input set of targets that may satisfy a request based on at least one rule. The method and system specifies the problem construct, recasts the problem construct as at least one of a set cover problem and an integer program and approximately solves the at least one set cover problem and the integer program.

### BACKGROUND OF THE INVENTION

1. Field of the Invention

The present invention generally relates to a system and method for selecting targets. More particularly, the present invention relates to a system and method for selecting targets based on business rules and resources using a set cover method or an integer program. In this invention, a target represents a choice from a set of potential choices.

2. Description of the Related Art

Conventional systems and methods for identifying targets based on business rules and resources have required hard coding of the policies that are used to find targets into the applications.

For example, a bank employee may desire to access data which may be protected by privacy-related rules, and such access may require approval by a person who is designated to review requests to access such data. In this application, a target is a person who reviews the access request. However, the number of requests to access such data may be very large and the size of the database is oftentimes immense. Therefore, control over who may access that data may be divided among several designated targets. Each target may be authorized to review and to approve requests for only portions of the data. This division of responsibility may take many forms and, in one example, the division of responsibility may be along geographical boundaries. For example, one designated target may be provided with the authority to review and approve requests to access data relevant to North America, while another designated target may be responsible for reviewing and approving requests to access data that is relevant to Europe, Asia, South America, and the like.

Further, the authority to grant access to data may be hierarchically divided across a database. For example, one designated target may be delegated the authority to review and approve requests for data relevant to the state of Ohio, another target may be responsible for requests to access data relevant the state of Virginia, and so on, while yet another designated target may have the authority to review and approve requests to access data that is relevant to the United States, another may have authority to review and approve for North America, another may have authority for the entire World.

Conventionally, the identification of appropriate targets has been done by processes that are designed to find any eligible targets instead of finding good targets. For example, if any of five targets can review a given request, a conventional method might stop as soon as it finds the first one of the five targets, regardless of whether another of the five targets would be better for that request. In some cases, this might be because the conventional systems and methods do not have a way of representing criteria which determine whether one target would be better than another. In other cases, this might be because processes for finding the better targets were not known.

Additionally, different reviews of requests by authorized targets may require that different amounts of resources be dedicated to obtain such reviews. For example, the cost to a bank to have a World authorized target review a request is likely to be higher than the cost to the bank to have a target having authorization for a smaller geographic area. Targets that have responsibility over a larger area are likely to have a larger compensation package. It is desirable to minimize this cost resource.

Other resources for which it may also be desirable to minimize may include, for example, the availability of targets, the amount of time required to review a request, and the like. It is desirable to select targets having the lowest resource requirements to review each request.

It may also be desirable to include resources besides cost, such as availability of time. It may also be desirable to include other logical constraints. For example, if there are three requests for approval and any one of several targets can approve them, it may be better to send all of them to one target to minimize the overhead involved in switching from the target's normal work to his or her “review” work.

Conventional methods and systems for identifying a target from a plurality of targets do not account for such resources or logical constraints, and merely provide the first target reached in a search and/or a list of all targets that may have authority.

Further, conventional methods may force the creation of many rules because the systems are not able to interpret general rules. When there are many rules, run-time increases, the administrative effort required to maintain the rules increases, and the probability of human error increases.

### SUMMARY OF THE INVENTION

In view of the foregoing and other exemplary problems, drawbacks, and disadvantages of the conventional methods and systems, an exemplary feature of the present invention is to provide methods and systems in which optimal targets are selected based on rules that specify which targets may satisfy a request.

In a first exemplary aspect of the present invention, a method of solving a problem construct includes specifying a problem construct that includes an input set of targets that may satisfy a request based on at least one rule, recasting the problem construct as one of a set cover problem or an integer program, and approximately solving the set cover problem or the integer program.

In a second exemplary aspect of the present invention, a system for solving a problem construct, includes means for specifying a problem construct that includes an input set of targets that may satisfy a request based on at least one rule, means for recasting the problem construct as at least one of a set cover problem and an integer program, and means for approximately solving the at least one set cover problem and the integer program.

In a third exemplary aspect of the present invention, a program embodied in a computer readable medium executable by a digital processing unit, includes instructions for specifying a problem construct that includes an input set of targets that may satisfy a request based on at least one rule, instructions for recasting the problem construct as at least one of a set cover problem and an integer program, and instructions for approximately solving the at least one set cover problem and the integer program.

In an exemplary embodiment of the present invention, a search for a target considers more than one target instead of choosing the first target it finds.

In an exemplary embodiment of the present invention, each set of targets may be assigned an objective value. A combinatorial optimization algorithm may match the request based on rules to a low or minimum objective value set of targets.

In an exemplary embodiment of the present invention, requests may have parts. Rules may specify which target can satisfy each part of a request.

A set cover algorithm is a type of combinatorial optimization algorithm. A set cover algorithm finds, with respect to an objective function, an approximately optimal set of targets that together cover all parts of the request.

In accordance with an exemplary embodiment of the present invention for a finite universe of elements, and a set of subsets of the elements, a set cover is a choice of the subsets that covers all of the elements. Each set of subsets can be assigned an objective value. A set cover algorithm finds a low or minimum objective value set cover. In this embodiment, the elements are the parts of a request. Each subset (in the set of subsets of the elements) corresponds to a target, and it is the set of parts of the request that the target covers (via the rules).

There are many types of set cover algorithms. Some are based on greedy and local search methods of combinatorial optimization. Some are based on formulating the set cover problem as a type of mathematical program.

If each target has a weight, and the objective function is evaluated for a set of targets by adding the weights of the targets, then the type of mathematical program is an integer linear program.

An exemplary embodiment of the invention may be used for computer application access management. Requests to obtain access to applications and data within those applications may be received and targets that are responsible for the applications and the data may be identified.

In an exemplary application for the present invention, access to a financial application may require approval of a request to gain access. Such a request may require an identification of a geographic area that defines the data to which the person submitting the request desires access. A set of business rules may determine the division of authority to targets to review and approve requests based upon, for example, geographic boundaries. This exemplary embodiment may receive the request and select one or more targets, so as to approximately optimize an objective function, using a set cover algorithm.

An exemplary embodiment of the present invention may be used with any application where the problem may be represented as a set of rules and the exemplary embodiment identifies one or more targets that satisfies those rules.

An exemplary embodiment of the present invention may be used to ensure that requests for information are reviewed and approved using well-documented and automated procedures. This helps with Sarbanes-Oxley rules compliance.

An exemplary embodiment may be used when there are multiple hierarchies and multiple potential approvers. For example, the bank application described above might have data related to a “place”, such as a state, a country, and a continent; and it might have data related to organizations. For example, the bank might have Banking, Investing, and Insurance “divisions”.

Furthermore, the divisions might be subdivided. An Insurance division, for example, might have Auto, Home, and Life subdivisions. Targets would have responsibility for either places, organizations, or both. For example, one target might be able to approve any request for data in the Life subdivision of the Insurance division, another target might be able to approve requests for data in the Insurance division in Asia, and another target might be able to approve any requests for data in Germany. The embodiment would have representations of the place and organization hierarchies and would be able to use these to find the targets with the least weight for any given request.

In another exemplary embodiment of the present invention, an objective function may be defined on the targets. Such an objective function may correspond, for example, to the cost of the resources that would be required to evaluate the request by sets of approvers within an appropriate organization. An exemplary embodiment may use a set cover algorithm that identifies zero or more targets, covering the request, having a low or the lowest value of the objective function.

In another exemplary embodiment of the present invention, weights and/or priorities may be assigned to the targets. Such weights and/or priorities may correspond, for example, to the cost, by target, of the resources that would be required to evaluate the request and/or the level of targets within an appropriate organization. The exemplary embodiment may create an objective function and then may use a set cover algorithm that identifies zero or more targets (e.g., the algorithm may identify a target(s) if such exists), covering the request, having low or lowest total weight and/or respecting the priorities.

Another advantage of the invention is the ability to select the optimum target or set of targets.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary target selection system 100 for incorporating the present invention therein;

FIG. 2 illustrates a signal bearing media 200 and 202 for storing steps of a program of a method according to the present invention;

FIG. 3 illustrates the operation of an exemplary system 300 in accordance with the present invention; and

FIG. 4 illustrates a flowchart 400 of an exemplary method in accordance with the present invention.

### DETAILED DESCRIPTION OF EXEMPLARY EMBODIMENTS OF THE INVENTION

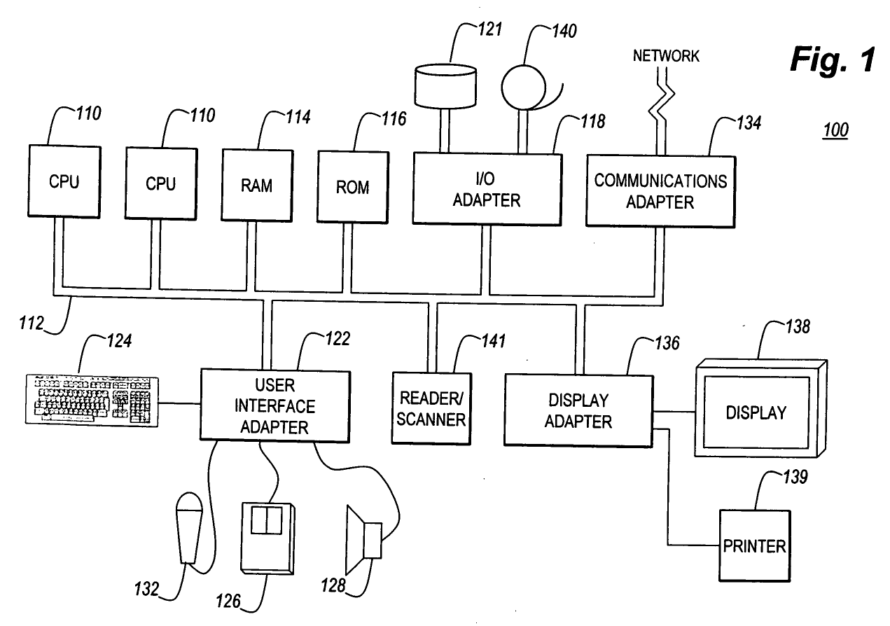

Referring now to the drawings, and more particularly to FIGS. 1-4, there are shown exemplary embodiments of the method and systems of the present invention.

FIG. 1 illustrates a typical hardware configuration of an information handling/computer system for use with the invention and which preferably has at least one processor or central processing unit (CPU) 110.

The CPUs 110 are interconnected via a system bus 112 to a random access memory (RAM) 114, read-only memory (ROM) 116, input/output (I/O) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or printer 139.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

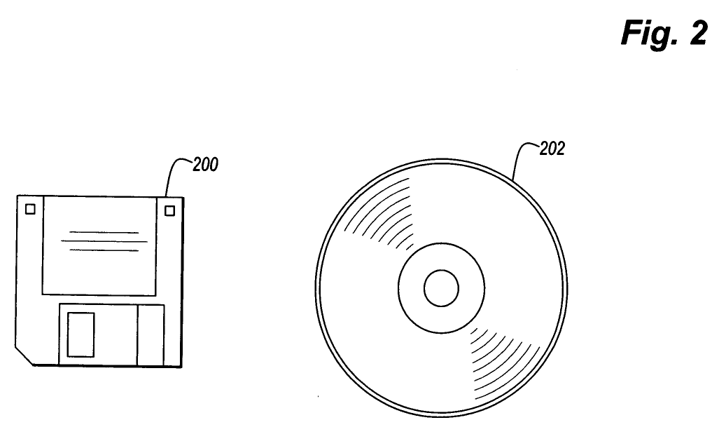

This signal-bearing media may include, for example, a RAM contained within the CPU 110, as represented by the fast-access storage for example. Alternatively, the instructions may be contained in another signal-bearing media, such as a magnetic data storage diskette 200, an optical disk 202, or the like (FIG. 2), directly or indirectly accessible by the CPU 110.

Whether contained in the diskette 200, the computer/CPU 110, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

One application for an exemplary embodiment of the present invention chooses one or more targets for a request for computer application access. In this embodiment, a user may enter the names of applications and choose ranges of data for which they request access. For example, a range may specify certain countries, certain geographies, and/or certain divisions. An aspect of the invention is to determine a set of targets that may authorize this request before access is granted.

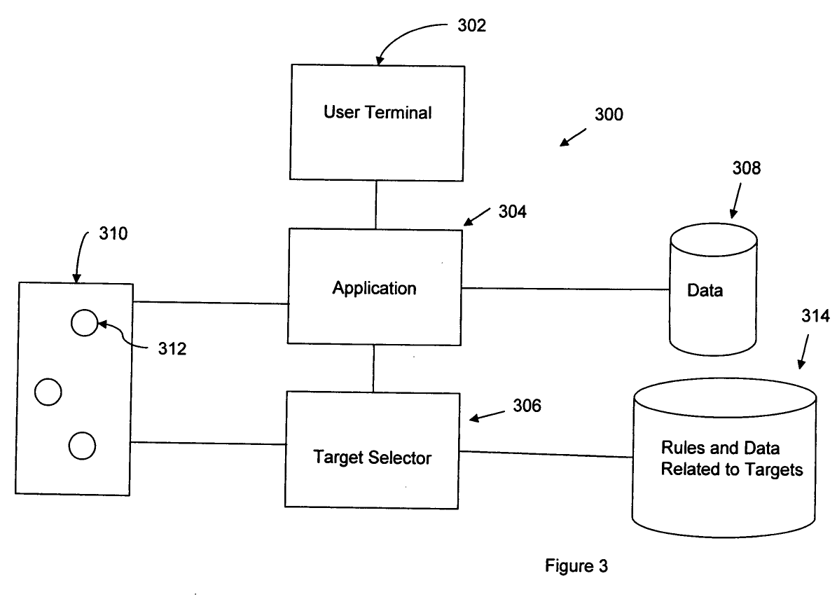

FIG. 3 illustrates the operation of an exemplary system 300 in accordance with the present invention. The system 300 includes a user terminal 302, an application 304, a target selector 306, a database 308, a plurality of targets 310, and a set 314 of rules and data related to the targets 310. The system 300 starts operation by a user terminal 302 sending a request to access and/or process at least a portion of the data in the database 308 using the application 304.

For example, a user (not shown) may operate the user terminal 302 to send a request to access checking accounts in the state of Texas using a financial reporting system (application 304). The database 308 may include financial data and a portion of that data may be relevant to checking accounts in the state of Texas.

As explained above, it may be desirable to control access to such financial data to avoid invasion and/or breach of privacy rights.

Thus, before the application 304 permits the user at the user terminal 302 to access the requested data, the application must determine whether the user is authorized to access the requested data. Authorization may only be granted by one or more of the targets 312 of the plurality of targets 310. Each of the targets 312 corresponding to an entity which is authorized to review and then either approve or reject requests to access the data in the database 308.

However, as explained above, there may be a plurality of targets 312 who have the capability of reviewing the request and it is desirable to identify the target 312 which is best for the requested access.

Therefore, the application 304 forwards the details of the request to the target selector 306 of the present invention. The target selector 306 obtains the rules for each target 312 of the plurality of targets 310. For example, the target selector 306 may receive a rule “Texas” for a target “Target A,” a rule “United States” for “Target B,” a rule “Europe” for “Target C,” et. seq.

The target selector 306 receives the rules for each of the plurality of targets 310 and uses a set cover algorithm to identify at least one of the plurality of targets 310, which covers the request slice. For example, the target selector 306 may use a set cover algorithm which identifies “Target A” as a target which covers the request slice “Texas” and “checking” because the rule for “Target A” is “Texas.”

The target selector 306 then provides the identity of “Target A” to the application 304, with which the application may communicate directly with “Target A” to obtain approval or denial of access to the requested data. The application 304 may then inform the user terminal 302 of the decision made by the target.

While the system 300 of FIG. 3 illustrates only a single application, an exemplary embodiment of the present invention may communicate with any number of applications, any number of different databases 308, and any number of different types of targets 312 and still practice the invention.

Further, while the system 300 of FIG. 3 illustrates that the application 304 forwards a request slice to the target selector 306, those of ordinary skill in the art understand that the target selector of the present invention may communicate directly with the user terminal and/or user and still practice the invention.

Further, while the system 300 of FIG. 3 illustrates that the application 304 forwards a single request slice to the target selector 306, those of ordinary skill in the art understand that an exemplary embodiment of the invention allows the application 304 to send multiple slices in one request and considers the plurality of slices when choosing one target 312 or a plurality of targets.

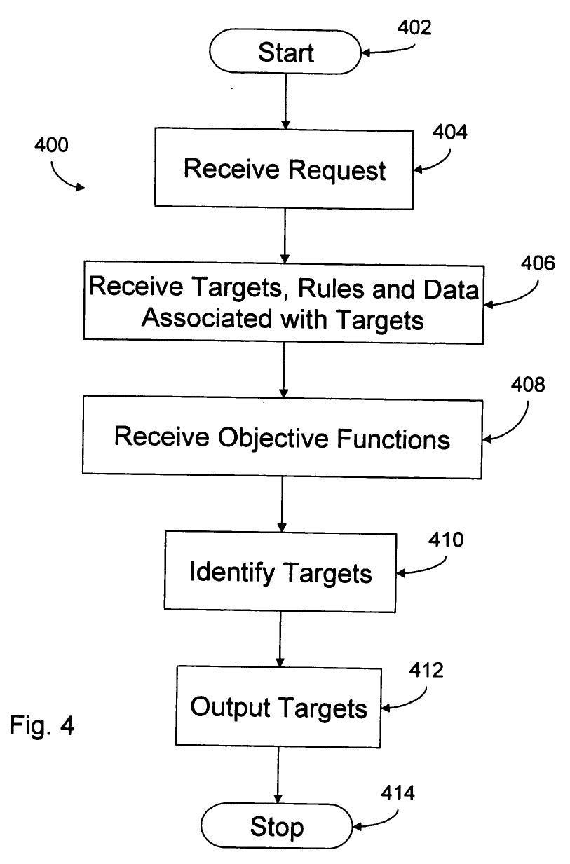

FIG. 4 illustrates a flowchart 400 in accordance with an exemplary method of the present invention. The flowchart 400 starts at 402 and continues to step 404, where the target selector 304 receives a request to access data. The flowchart 400 continues to step 406, where the target selector 304 receives data regarding targets from the database 308, rules associated with those targets, and data associated with the targets from the database 314 and continues to step 408. In step 408, the target selector 306 receives an objective function and continues to step 410.

In step 410, the target selector 304 identifies at least one target based upon the request, the targets and target rules, and the objective function using a set cover algorithm and continues to step 412. In step 412, the target selector 304 outputs the identified target and continues to step 414 where the flowchart ends.

The requests that are submitted to an exemplary embodiment of this invention might be generated using an input form (not shown). Such an input form could contain field names and field values. For example, an input field name could be “state” and input form values for State could include “Texas”, “California”, and “Florida”. For a given set of input form field names and values, there may be a field-space, where each field name is a dimension and each point in the space contains a value for each field.

A field name may inherit from one other field name. However, the chain of inheritance for the field names may not be circular. If a field name is inherited, then each value of the field must be inherited from exactly one value from a parent field.

A slice in this field value space may include a set where there are values for some of the field values and wild cards for other field values, subject to the constraint that for each field-name value pair in the slice, ancestor fields may only contain ancestor field values.

In accordance with an exemplary embodiment of the present invention, a field name may be “state” and field values may include, for example, “Oklahoma,” “Texas,” “New Mexico,” and the like. A parent field value for these field values may be “United States” and the field name corresponding to the value “United States” may be “country” Another field name may be “bank accounts” and field values may include, for example “savings,” “checking,” “money market” and the like. A field name for these field values may be “bank account.”

A slice across such a field space may be “all points such that for field name ‘state’ the field value is Texas and for the field name country the field value is ‘United States.’” In this representation of the slice, the allowable field values for field name “bank account” are implicit. Another representation would state that the slice is “all points such that for field name ‘state’ the field value is Texas and for field name ‘country’ the field value is ‘United States’ and for field name ‘bank account’ the field value is a wild card.” (This uses the standard notion of a wild card matching any allowable value.). These two representations are the same except that the wild cards are explicit in one and implicit in the other.

A request may have an identifier and a set of slices. For example, a request for the above field space may be, for example, “Texas” and “checking.” More formally, this could be represented by “for field name ‘state’, field value is ‘Texas’; and for field name ‘bank account’, field value is ‘checking.’” This is not necessary in this exemplary embodiment because each field value is associated with only one field name.

A target may be identified by a unique identifier. A rule may be a slice and a target. For example, a rule may be, for example, “Texas” and “Target A” which indicates that the target identified by “Target A” has the authority to approve or reject requests for access to any data having the field value “Texas.” A rule may cover a request slice if, for each field, the value in the rule is not a wild card and the value in the rule is the same as the value in the request slice. There may be a plurality of rules for each target. A target may cover a request slice if one of the rules for that target covers the request slice. A solution to the request may be a target. Since, the rule “Texas” and “Target A” covers the request slice “Texas” and “checking” for this example, then the target identified by “Target A” covers the request slice and a solution to the set cover problem is “Target A.” Using this, it is possible to define “satisfy”: a target satisfies a request slice if and only if the target covers the request slice.

One exemplary embodiment of the present invention provides a method related to computer application input processing. The method includes reading in a set of field names, reading in a set of field values for each field name, reading in targets and rules, reading an objective function on the targets and data that is used in the objective function, reading a request, and finding a solution that approximately optimizes the objective function and covers an optimal number of request slices.

An exemplary embodiment of the present invention may read specifications of the resources of targets, read in capacities of the resource of each target, read in data and a calculation that is used to compute the resources required for each slice in the request, and find a solution that approximately optimizes an objective function and which covers an optimum number of request slices while respecting the resource capacities of the targets and the resource requirements of the request.

An exemplary embodiment of the present invention may read in a set of field names, read in a set of field values for each field name, read in targets and rules, read in weights for the targets, use a predefined objective function that finds a low value for the sum of the weights of the targets, and find a solution that approximately optimizes the objective function and covers an optimal number of request slices.

An exemplary embodiment of the present invention may be used to satisfy a request to identify one or more targets using rules having the following form:

If value(FieldName[1]) == Value[1] & value(FieldName[2]) ==
Value[2] & . . . & value(FieldName[N]) == Value[N] then the
target is T.

where:

Value[i] may be an actual allowable value for FieldName[i] or a wild card.

A problem construct is a complete specification of the problem to be solved. It may have a limited or an unlimited number of rules of this form and a list of the targets along with an objective function and optionally a list of rules that specify inheritance between the field names and values. It also contains the request, which may have zero or more slices.

In one exemplary embodiment of the invention, weights can be used to automatically construct an objective function. A variant of the problem construct does not have an objective function but has data that is used to automatically construct an objective function.

A problem construct also admits types of rules that are different from the rules described above. Any function that determines whether a target is allowed to cover a slice can be used as a rule.

For example, a problem construct for a teller in a bank who requests access to an application and a database for the application may look like this:
Request: <Field Name: Country, Field Value: United States>,
Rules: if Field Name==Country and Field Value==United States then Target=Joe; if Field Name==Country and Field Value=Canada then Target=Jane.
Weights: weight[Joe]=5, weight[Jane]=7.

Each request would include a set of field names and values. Then based on that request, a set cover algorithm finds one or more targets to satisfy that request.

An exemplary embodiment of the present invention may take a virtually unlimited number of rules of this form and find the optimal set of targets for a request.

An exemplary embodiment of the present invention may also take into account factors such as target workload and resource availability.

An exemplary embodiment of the present invention may provide an automated method of finding approvers for authorization requests without hard coding rules, field names, field values, and objective functions.

An exemplary embodiment of the present invention may be used for privacy protection and/or for Sarbanes—Oxley compliance. In this manner, an exemplary embodiment may protect investors by improving the accuracy and reliability of corporate disclosures made pursuant to the securities laws of the United States of America.

An exemplary description of how a set cover problem may be formulated in accordance with the present invention follows.

As explained above, a rule may be a set of slices that provide attributes and values for those attributes, although some of those values may be wild cards. For example, a rule may state: North American geography and a model number of a machine.

Rules are owned by targets. In an exemplary embodiment, the rules are owned by approvers and are used by the approvers to review and/or approve requests.

In accordance with an exemplary embodiment of the present invention, each request slice is matched with a target that owns a rule that can approve that slice.

A rule may be exactly the same as a request or it may be something more general. More general means that, for every attribute value in a request, the target has a rule which either has that attribute value or has something more general. Something general might mean, for example, geography that includes a country, or it may be the most general where it is a wild card.

In accordance with an exemplary embodiment of the present invention, a target set which covers a request may be determined by solving the following:

$${\sum }_{T ∈ T : T ≻ S} x ( T ) \geq z ( S ) , ∀ S ∈ S . \qquad ( 1 )$$

where:

T is a set of targets;

T is a target;

S is a set of slices associated with a request.

S is a request slice;

T [symbol] S denotes that target T covers request slice S.

For TεT, let x(T) be a 0/1 variable indicating whether or not target T is selected in the solution. Let x denote the vector of x(T).

For SεS, let z(S) be a 0/1 variable indicating whether or not request slice S is selected in the solution.

Let f: {0,1}^{T} [symbol] R denote the objective function that is approximately minimized in accordance with an exemplary embodiment of the present invention. Where R is a set of rules, an element for R is R=(U,T), U is a slice, and T is a target.

For TεT and SεS such that T covers S, let y(T,S) be a 0/1 variable indicating whether or not target T is assigned to request slice S in the solution.

An exemplary embodiment of the present invention may determine targets for a request slice where the resources are constrained. This exemplary embodiment ensures that the request will not exceed the resources that are available to a particular target by solving:

$${\sum }_{S ∈ S} a ( M , S ) \times y ( T , S ) \leq b ( M , T ) , ∀ M ∈ M , T ∈ T . \qquad ( 2 )$$

### Where:

M is a set of resources;

b(M,T) is an endowment of resources for target T;

a(M,S) is the amount of resources required by a request slice S; and

y(T,S) is defined above.

An endowment of resources for a target may include, for example, time, budgeted dollars, and the like.

An exemplary embodiment of the present invention identifies an optimal set of targets covering the request using an Integer Linear Programming (ILP) problem.

An exemplary embodiment of the present invention identifies the maximum number of slices that can be covered by optimizing the following objective function:

$$max {\sum }_{S ∈ S} z ( S ) . \qquad ( 3 )$$

subject to the constraints (1) and (2) above and the following additional constarints:

$$\begin{matrix}{\sum }_{S ∈ S : T ≻ S} y ( T , S ) \leq x ( T ) , ∀ T ∈ T . \\ and & ( 4 ) \\ {\sum }_{T ∈ T : T ≻ S} y ( T , S ) = z ( S ) , ∀ S ∈ S . & ( 5 )\end{matrix}$$

Let z* be the objective value of this solution.

Next, choose a coverage proportion τ such that 0<τ≦1. τ is a user-specified proportion of the maximum-number of slices that are required to be covered. For example, if it is calculated that z*=15 slices can be covered and the coverage proportion is 0.8, then there is a desire to minimize cost over solutions that have at least 12 slices covered. If it is desired to cover as many request slices as possible, then the coverage proportion should be set to 1.0. Coverage proportions should be chosen based on business considerations. Factors that are relevant include the cost of not covering a slice.

Find an approximately optimal solution to the Integer Non-Linear Programming (INLP) problem comprising:

min f(x). (6)

$${\sum }_{S ∈ S} z ( S ) \geq τ {z}^{*} . \qquad ( 7 )$$

and equations (1), (2), (4) and (5) set forth above.

The solution of equation (6) identifies selected targets, covered request slices, and an assignment of covered slices to selected slices respecting the rules and resource limitations.

Another exemplary embodiment of the present invention is capable of accounting for priorities of various targets by assigning a weight to each target. For example, in the banking example set forth above, an approver that is at a higher level of management within the bank hierarchy may be assigned a higher weight than an approver who is at a lower level of management.

In this embodiment, the process proceeds as described above, except, rather than optimizing formula (6), the following formula (8) is optimized:

$$min {\sum }_{T ∈ T} w ( T ) \times x ( T ) . \qquad ( 8 )$$

where:

w is the weight assigned to a target.

Yet another embodiment of the present invention identifies targets that cover request slices without regard to resource constraints. In this embodiment, for all request slices S that cannot be covered by some target in T, fix z(S)=0 for all other request slices, fix z(S)=1.

This embodiment then optimizes the formula (8), subject to the constraints (1), as a set cover problem with a linear objective. Finding a good or optimal solution identifies selected targets.

While the invention has been described in terms of several exemplary embodiments, those skilled in the art will recognize that the invention can be practiced with modification.

While the application discusses approximately solving a set cover problem or an integer program, one of ordinary skill in the art understands that approximately solving covers exactly solving.

While the exemplary embodiments described above refer to an input set of targets, it is to be understood that the claims of the present invention cover an input set having no targets, one target, or a plurality of targets, whether they cover a request or not. Further, the present invention includes a problem construct having a request that is based on one rule or a plurality of rules.

While the previous exemplary embodiments refer to “business rules” it is to be understood that this term is used in a general sense as understood by those of ordinary skill in the information technology arts. The present invention is not limited to application to businesses. Rather, the present invention may be applied in any domain that has rules, regardless of whether that domain is a business domain or not.

Further, it is noted that, Applicant's intent is to encompass equivalents of all claim elements, even if amended later during prosecution.

What is claimed is:

1. A method of formulating and solving a problem construct, comprising:
specifying a problem construct that includes an input set of targets that may satisfy a request based on at least one rule;
recasting the problem construct as at least one of a set cover problem and an integer program; and
approximately solving the at least one set cover problem and the integer program.

2. The method of claim 1, wherein said approximately solving comprises solving the problem construct using a set cover technique.

3. The method of claim 1, wherein said approximately solving comprises solving the problem construct using an integer program.

4. The method of claim 1, wherein said specifying the problem construct comprises reading in rules for each of said targets, and wherein each rule comprises at least one pair of field names and field values.

5. The method of claim 4, wherein said specifying the problem construct further comprises:
reading in an objective function on the targets;
reading in data that is used by the objective function; and
reading in the request, wherein said approximately solving comprises approximately optimizing the objective function.

6. The method of claim 5, further comprising updating the objective function.

7. The method of claim 4, wherein the field names and field values are received by reading an input form completed by a computer user.

8. The method of claim 4, where at least one of said field-name-field-value pairs is represented by one value.

9. The method of claim 1, wherein said specifying the problem construct comprises:
reading in specifications of resources for each of the targets;
reading in capacities of the resources for each of the targets; and
reading in data and computing the resources required for each slice in the request.

10. The method of claim 9, wherein said solving the problem construct comprises:
determining an approximately optimal solution with respect to the objective function, that covers a user-specified proportion of the maximum-number of slices that can be covered, and that does not exceed the capacities of the resources of the targets.

11. The method of claim 1, wherein said specifying the problem construct comprises considering a weight for each of the input targets, and wherein said solving the problem construct comprises approximately optimizing an objective function.

12. A system for formulating and solving a problem construct, comprising:
means for specifying a problem construct that includes an input set of targets that may satisfy a request based on at least one rule;
means for recasting the problem construct as at least one of a set cover problem and an integer program; and
means for approximately solving the at least one set cover problem and the integer program.

13. The system of claim 12, wherein said means for approximately solving the problem construct comprises means for approximately solving the problem construct using a set cover technique.

14. The system of claim 12, wherein said means for specifying the problem construct means for reading in rules for each of said targets, and wherein each rule comprises at least one pair of field names and field values.

15. The system of claim 13, wherein said means for specifying the problem construct further comprises:
means for reading in an objective function on the targets;
means for reading in data that is used by the objective function; and
means for reading in the request, wherein said means for approximately solving the problem construct comprises means for approximately optimizing the objective function.

16. The system of claim 15, further comprising means for updating the objective function.

17. The system of claim 14, wherein the field names and field values are received by means for reading an input form completed by a computer user.

18. The system of claim 12, wherein said means for specifying the problem construct comprises:
means for reading in specifications of resources for each of the targets;
means for reading in the capacities of the resources for each of the targets; and
means for reading in data and computing the resources required for each slice in a request.

19. The system of claim 18, wherein said means for approximately solving the problem construct comprises means for determining an approximately optimal solution with respect to the objective function, that covers a user-specified proportion of the maximum-number of slices that can be covered, and that does not exceed the capacities of the resources of the targets.

20. A program embodied in a computer readable medium executable by a digital processing unit, said program comprising:
instructions for specifying a problem construct that includes an input set of targets that may satisfy a request based on at least one rule;
instructions for recasting the problem construct as at least one of a set cover problem and an integer program; and
instructions for approximately solving the at least one set cover problem and the integer program.
